(19) United States
(12) Patent Application Publication
(10) Pub. No.: US 2024/0181449 A1
(43) Pub. Date: Jun. 6, 2024

(54) MICROFLUIDIC DEVICE CHANNEL SPLITTING

(71) Applicant: Hewlett-Packard Development Company, L.P., Spring, TX (US)

(72) Inventors: Carson DENISON, Corvallis, OR (US); Pavel KORNILOVICH, Corvallis, OR (US); Richard W. SEAVER, Corvallis, OR (US); Anand Samuel JEBAKUMAR, Corvallis, OR (US); Erik D. TORNIANEN, Corvallis, OR (US); Alexander GOVYADINOV, Corvallis, OR (US)

(73) Assignee: Hewlett-Packard Development Company, L.P., Spring, TX (US)

(21) Appl. No.: 18/550,286

(22) PCT Filed: Apr. 6, 2021
(86) PCT No.: PCT/US2021/025896

§ 371 Date: Sep. 12, 2023

(51) Int. Cl. B01L 3/00

(52) U.S. Cl. CPC B01L 3/502715; B01L 2300/0864; B01L 2300/161; B01L 2400/0406

(57) ABSTRACT

A microfluidic device includes a first channel, second channels, and a transition channel splitting the first channel into the second channels. The transition has a first end fluidically connected to the first channel and a second end fluidically connected to the second channels. The transition channel expands in width from a width of the first channel at the first end to no less than a sum of widths of the second channels at the second end so as to promote fluid flow from the first channel to the second channels.

### BACKGROUND

Microfluidic devices leverage the physical and chemical properties of liquids and gases at a small scale, such as at a sub-millimeter scale. Microfluidic devices geometrically constrain fluids to precisely control and manipulate the fluids for a wide variety of different applications. Such applications can include digital microfluidic (DMF) and DNA applications, single cell applications, as well as applications as varied as lab-on-a-chip, inkjet, microreactors, electrophoresis, capacitance sensing, fluidic heat sink, and fluidic sensor probe applications, among other applications.

### BRIEF DESCRIPTION OF THE DRAWINGS

FIGS. 1A and 1B are cross-sectional top view and front view diagrams, respectively, of an example microfluidic device having a linearly expanding, symmetrical two-way channel-splitting transition channel.

FIG. 2 is a cross-sectional top view diagram of an example microfluidic device having a linearly expanding, asymmetrical two-way channel-splitting transition channel.

FIG. 3 is a cross-sectional top view diagram of an example microfluidic device having consecutive linearly expanding, asymmetrical two-way channel-splitting transition channels.

FIG. 4 is a cross-sectional top view diagram of an example microfluidic device having a linearly expanding, symmetrical three-way channel-splitting transition channel.

FIG. 5 is an example channel expansion angle graph for non-linear expansion of a channel-splitting transition channel.

FIGS. 6A and 6B are cross-sectional top view diagrams of example microfluidic devices that each have a non-linearly expanding, symmetrical two-way channel-splitting transition channel.

FIG. 7 is a block diagram of an example microfluidic device with channel expansion that promotes fluid flow.

### DETAILED DESCRIPTION

Microfluidic devices often include channels. Fluid may passively or actively flow from a first channel that splits into multiple second channels. Active fluid flow results when external forces, such as due to microfluidic pumps, assist the flow of fluid. By comparison, passive fluid flow results when no such external forces assist the flow of fluid, and instead capillary and other forces resulting from the interaction of the fluid and the material from which the microfluidic device is fabricated cause the flow of fluid.

When the channels are empty of fluid and instead contain air or other gas, causing fluid to initially flow into the first channel and then from the first channel to and through the second channels is referred to as priming. Priming may fail, however. For instance, the initial capillary and other forces may be insufficient for the fluid to flow much past the inlets of the second channels, which is a phenomenon referred to as pinning. Even if pinning does not occur, the flow of fluid through the second channels may be incomplete. Specifically, the fluid may trap air or other gas pockets at sidewalls of the second channels.

A microfluidic device is described herein that ameliorates these and other issues that can occur during priming. The microfluidic device includes a first channel and multiple second channels. The microfluidic device includes a transition channel that splits the first channel into the second channels. The transition channel has a first end fluidically connected to the first channel and a second end fluidically connected to the second channels. The transition channel expands in width from the width of the first channel (where the first channel meets the transition channel) to no less than the sum of the widths of the second channels (where the second channels meet the transition channel) so as to promote fluid flow from the first channel to the second channels. As such, priming can properly occur without fluidic pinning or the trapping of air or other gas pockets at channel sidewalls.

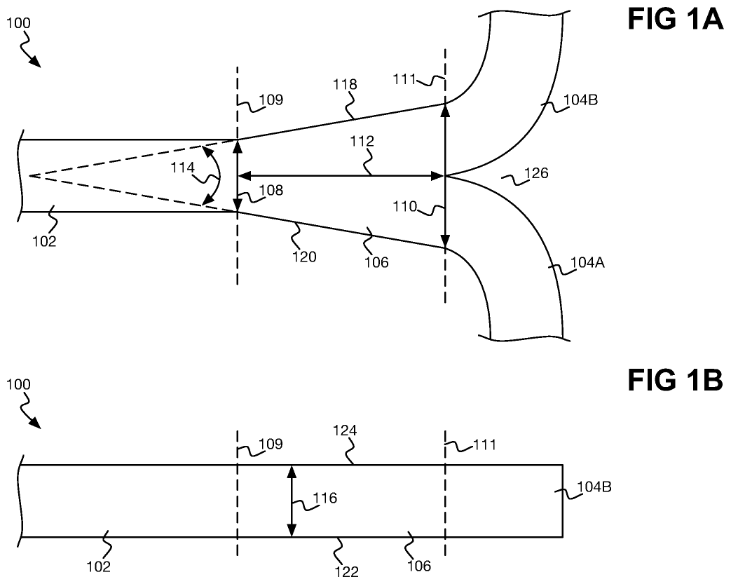

FIGS. 1A and 1B show cross-sectional top and front views, respectively, of an example microfluidic device 100. The microfluidic device 100 includes a first channel 102 and two second channels 104A and 104B, which are collectively referred to as the second channels 104. While there are two second channels 104 in the example, there may be more than two such channels 104. The microfluidic device 100 includes a transition channel 106 having a first end 109 fluidically connected to the first channel 102 and a second end 111 fluidically connected to the second channels 104.

The transition channel 106 two-way splits the first channel 102 into the second channels 104 in the example, because there are two second channels 104. The microfluidic device 100 includes a split wedge 126 between the second channels 104, which are adjacent to one another, at the second end 111 of the transition channel 106. If there are more than two second channels 104, than there is a split wedge 126 between each pair of adjacent second channels 104.

The transition channel 106 is further a channel that transitions the first channel 102 to the second channels 104. The transition channel 106 has sidewalls 118 and 120, a floor 122, and a ceiling 124. The length 112 of the transition channel 106 is defined between the ends 109 and 111, and the height 116 of the transition channel 106 is defined between the floor 122 and the ceiling 124. The height 116 of the transition channel 106, the first channel 102, and each second channel 104 is identical.

The transition channel 106 linearly expands in width from a width 108 at the first end 109 that is equal to the width of the first channel 102 specifically at the first end 109 to a width 110 at the second end 111 that corresponds to (e.g., is equal to) no less than the sum of the widths of the second channels 104 specifically at the second end 111 of the channel 106.

The width of each second channel 104 may be equal to or different than the width of the first channel 102, and the widths of the second channels 104 may be equal to or different than each other. In the example, the width of each second channel 104 is equal to the width of the first channel 102.

In the example, the width 110 of the transition channel 106 at the second end 111 is equal to the sum of the widths of the second channels 104. This is because the second channels 104 split away from one another beginning at a point. That is, the second channels 104 meet one another at the second end 111 of the transition channel 106 at a point, such that the split wedge 126 in effect has no width at the second end 111 of the transition channel 106.

However, due to fabrication constraints, the split wedge 126 may have a minimum non-zero width at the second end 111 of the transition channel 106 at which the second channels 104 split away from one another. In such instance, the width 110 of the transition channel 106 at the second end 111 is equal to the sum of the widths of the second channels 104 at the second end 111 and the width of the split wedge 126 at the second end 111. More generally, therefore, the width of the transition channel 106 at the second end 111 is no less than the sum of the widths of the second channels 104 at the second end 111.

The second channels 104 are depicted as having constant width, but either or both may instead be variable. If the width of either or both second channels 104 is variable, the width of the transition channel 106 at the second end 111 is equal to no less than the sum of the widths of the channels 104 specifically where they meet the channel 106 (i.e., at the end 111). That is, it is the sum of the widths of the second channels 104 where they meet the transition channel 106 at the second end 111 of the channel 106 that the width of the transition channel 106 is no less than at the end 111.

Similarly, the first channel 102 is depicted as having constant width, but may instead be variable. If the width of the first channel 102 is variable, the width of the transition channel 106 at the first end 109 is equal to the width of the channel 102 where it meets the channel 106 (i.e., at the end 109). That is, it is the width of the first channel 102 where it meets the transition channel 106 at the first end 109 of the channel 106 that the width of transition channel 106 is equal to at the end 109.

The expansion in width of the transition channel 106 from the first end 109 to the second end 111 is linear in that the angle at which the channel 106 expands, or increases, from the width 108 to the width 110 along its length 112 is constant. The angle 114 is specified to promote fluid flow from the first channel 102 to the second channels 104 so that priming can properly occur without fluidic pinning, and so on. The angle 114 is based on the fluidic contact angle.

The fluidic contact angle is the contact angle of the liquid fluid that is to flow from the first channel 102, through the transition channel 106, and to the second channels 104 during priming. The fluidic contact angle is the angle where a liquid-gas interface of the fluid meets a solid surface, such as the sidewalls 118 and 120 of the transition channel 106, and can be measured from the solid surface through the fluid. The fluidic contact angle is thus dependent on the material of the sidewalls 118 and 120 (i.e., the material from which the microfluidic device 100 is fabricated) and on the gas (e.g., air) that fluidic priming displaces, in addition to the liquid fluid itself. The fluidic contact angle is also dependent on temperature and pressure.

The angle 114 is specifically no greater than two times the difference between 90 degrees and the fluidic contact angle. For example, for water on SU-8 epoxy negative photoresist, the fluidic contact angle is approximately 80 degrees at room temperature and atmospheric pressure. Therefore, the angle 114 in such an implementation is no greater 20 degrees, and in the example of FIG. 1A is specifically 20 degrees.

In the example, the transition channel 106 symmetrically splits the first channel 102 into the second channels 104. That is, the second channels 104 symmetrically extend away from one another at the second end 111 of the transition channel 106 relative to a center line of the channel 106 along its length 112. However, the transition channel 106 may instead asymmetrically split the first channel 102 into the second channels 104.

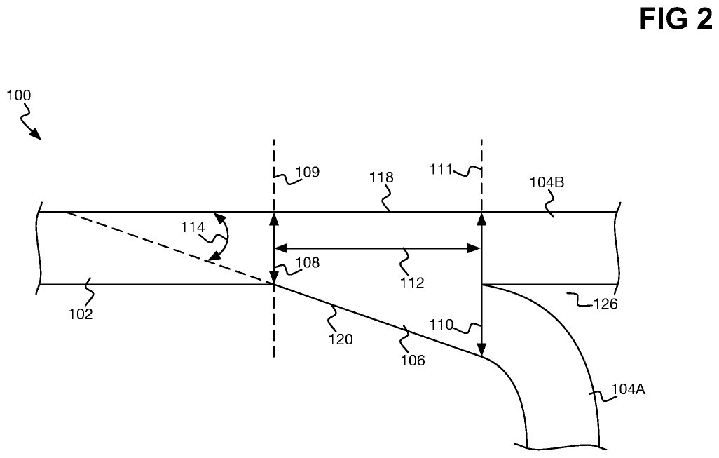

FIG. 2 shows a cross-sectional top view of such an example microfluidic device 100. The microfluidic device 100 again includes the first channel 102 and two second channels 104, although there may be more than two second channels 104. The transition channel 106 of the microfluidic device 100 is fluidically connected to the first channel 102 at the first end 109 and to the second channels 104 at the second end 111 as before, with the length 112 of the channel 106 defined between the ends 109 and 111.

The transition channel 106 similarly two-way splits the first channel 102 into the second channels 104 in FIG. 2, with the microfluidic device 100 including the split wedge 126 between the second channels 104.

The transition channel 106 transitions the first channel 102 to the second channels 104, and has sidewalls 118 and 120. As in FIG. 1A, the transition channel 106 linearly expands in width at the angle 114 from the width 108 of the first channel 102 at the first end 109 to the width 110 at the second end 111 that is equal to no less than the sum of the widths of the second channels 104 at the second end 111. The angle 114 is no greater than two times the difference between 90 degrees and the fluidic contact angle.

However, unlike in FIG. 1A, the transition channel 106 in FIG. 2 asymmetrically splits the first channel 102 into the second channels 104. That is, the second channels 104 asymmetrically extend away from one another at the second end 111 of the transition channel 106 relative to a center line of the channel 106 along its length 112. Specifically, the second channel 104A extends downwards, whereas the second channel 104B continues in the same direction as the first channel 102 and the transition channel 106.

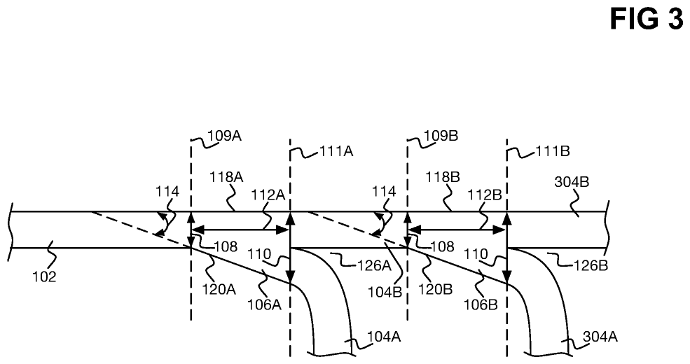

FIG. 3 shows a cross-sectional top view of another example microfluidic device 100. The microfluidic device 100 again includes the first channel 102 and two second channels 104, although there may be more than two second channels 104. The microfluidic device 100 also includes third channels 304A and 304B, which are collectively referred to as the third channels 304. While there are two third channels 304 in the example, there may be more than two such channels 304. In the example, the widths of the first channel 102, each second channel 104, and each third channel 304 are constant and equal to one another, but may differ from one another and/or be variable.

The microfluidic device 100 includes two transition channels 106A and 106B, which are collectively referred to as the transition channels 106. The first transition channel 106A is fluidically connected to the first channel 102 at a first end 109A and to the second channels 104 at a second end 111A, with a length 112A of the channel 106A defined between the ends 109A and 111A. The second transition channel 106B is fluidically connected to the second channel 104B at a first end 109B and to the third channels 304 at a second end 111B, with a length 112B of the channel 106B defined between the ends 109B and 111B. The lengths 112A and 112B may be equal to or different from one another.

The first transition channel 106A two-way splits the first channel 102 into the second channels 104, with the microfluidic device 100 including a split wedge 126A between the second channels 104. The second transition channel 106B similarly two-way splits the second channel 104B, which can be considered a selected such channel 104B in this respect, into the third channels 304, with the microfluidic device 100 including a split wedge 126B between the third channels 304. The split wedges 126A and 126B may be collectively referred to as the split wedges 126.

The transition channel 106A transitions the first channel 102 to the second channels 104, and has sidewalls 118A and 120A. The transition channel 106B similarly transitions the second channel 104B to the third channels 304, and has sidewalls 118B and 120B. The transition channel 106A linearly expands in width at the angle 114 from the width 108 of the first channel 102 at the first end 109A to the width 110 at the second end 111A that is equal to no less than the sum of the widths of the second channels 104 at the second end 111A. The transition channel 106B linearly expands in width at the same angle 114 from the width 108 of the second channel 104B at the first end 109B to the width 110 at the second end 111B that is equal to no less than the sum of the widths of the third channels 304 at the second end 111B. The angle 114 is no greater than two times the difference between 90 degrees and the fluidic contact angle.

FIG. 3 thus shows how the first channel 102 may be split into multiple channels 104A, 304A, and 304B via two consecutive transition channels 106. There may be more than two transition channels 106. For example, there may also be a transition channel 106 fluidically connected to the third channel 304B that splits the third channel 304 into multiple channels.

As another example, there may also or instead be a transition channel 106 fluidically connected to the second channel 104A that splits the channel 104A into multiple channels. As a third example, there may also or instead be a transition channel 106 fluidically connected to the third channel 304A that splits the channel 304A into multiple channels.

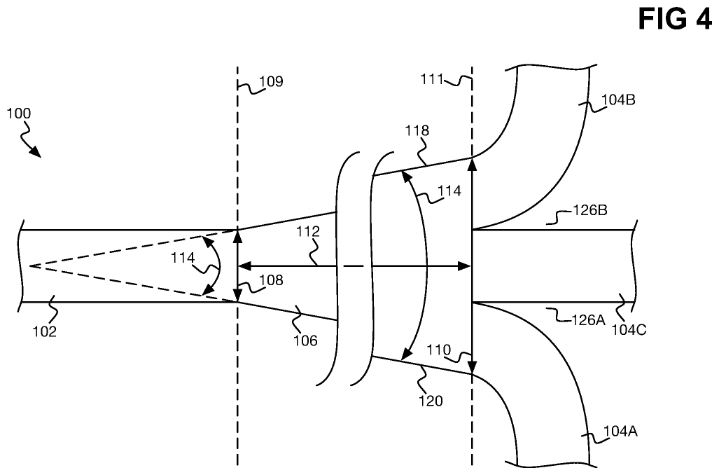

FIG. 4 shows a cross-sectional top view of another example microfluidic device 100. The microfluidic device 100 again includes the first channel 102, but instead of two second channels 104 as in the prior examples, includes three second channels 104A, 104B, and 104C. The transition channel 106 of the microfluidic device 100 is fluidically connected to the first channel 102 at the first end 109 and to the second channels 104 at the second end 111 as before, with the length 112 of the channel 106 defined between ends 109 and 111.

The transition channel 106 thus symmetrically three-way splits the first channel 102 into three second channels 104 in FIG. 4. The microfluidic device 100 includes a split wedge 126A between the second channels 104A and 104B, which are adjacent to one another, and a split wedge 126B between the second channels 104B and 104C, which are adjacent to one another. The split wedges 126A and 126B can be collectively referred to as the split wedges 126.

The transition channel 106 transitions the first channel 102 to the second channels 104, and has sidewalls 118 and 120. As in the prior examples, the transition channel 106 linearly expands in width at the angle 114 from the width 108 of the first channel 102 at the first end 109 to the width 110 at the second end 111 that is equal to no less than the sum of the widths of the second channels 104 at the second end 111. The angle 114 is no greater than two times the difference between 90 degrees and the fluidic contact angle.

In the examples that have been described, if the width 110 of the transition channel 106 at the second end 111 is significantly larger than the width 108 at the first end 109, linear expansion of the transition channel 106 at an angle 114 equal to 20 degrees can result in the channel 106 having a relatively long length 112. The microfluidic device 100 may thus have to be relatively larger than desired, and/or more of the spatial real estate of the microfluidic device 100 may have to be reserved for the transition channel 106 than desired. Therefore, the transition channel 106 may instead non-linearly expand in width from the width 108 to the width 110 across its length 112 in such a way so as to minimize this length 112 of the channel 106, while still promoting fluid flow during priming.

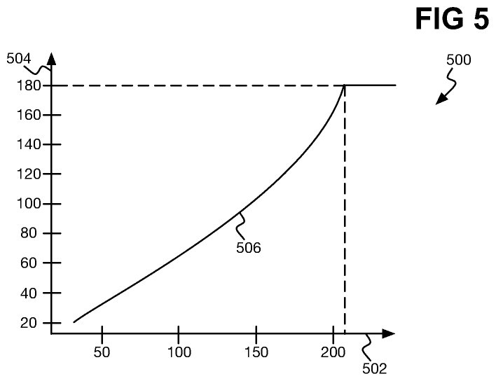

FIG. 5 shows an example graph 500 of the increasing angle at which the transition channel 106 can non-linearly expand in width along its length 112 to promote fluid flow while minimizing the length 112 of the channel 106. The x-axis 502 of the graph 500 denotes the width, in microns, of the transition channel 106, whereas the y-axis 504 of the graph 500 denotes the angle, in degrees, at which the channel 106 is to expand in width.

The line 506 of the graph 500 therefore specifies the angle at which the channel 106 is to expand in width at any given width of the channel 106.

Non-linear expansion of the width of the transition channel 106 means that the angle at which the channel 106 expands across its length 112 is variable, and more specifically increases with increasing width. That is, as the transition channel 106 increases in width, the angle at which the channel 106 expands also increases as governed by the line 506. This increasing angle is based (at least) on the fluidic contact angle. The line 506 in the example of FIG. 5 is specific to the case of a contact angle of 80 degrees, a channel height of 31 microns, and a fluidic surface tension of 70 dynes/centimeter (dyn/cm).

More generally, the transition channel 106 non-linearly expands in width along its length 112 so as to maintain a specified (positive) net capillary fluidic force along the length 112 to promote fluidic flow and thus ensure that priming properly occurs. The net capillary fluidic force is specified per the force balance equation F₀=2y[w cosθ+h cos (θ+^{ϕ}/₂)]. In this equation, F₀ is the net capillary fluidic force, y is the fluidic surface tension, θ is the fluidic contact angle, ϕ is the increasing angle at which the transition channel 106 non-linearly expands in width (i.e., locally expands in width), w is the width of the channel 106, and h is the height of the channel 106. The fluidic surface tension y may depend on the material from which the microfluidic device 100 is fabricated and/or the fluid (i.e., liquid) flowing through the channel 106, as well as other parameters, such as temperature and atmospheric pressure.

The positive first term 2y[w cosθ] of the net capillary fluidic force F₀ is per the force balance equation contributed by the floor 122 and the ceiling 124 of the transition channel 106 between its sidewalls 118 and 120. This term is thus based on the width w of the channel 106, the fluidic contact angle θ, and the fluidic surface tension y. More specifically, this term is based on the cosine of the fluidic contact angle θ, multiplied by the width w and two times the fluidic surface tension y.

The negative second term 2y[h cos(θ+^{ϕ}/₂)] of the net capillary fluidic force F₀ is per the force balance equation contributed by the sidewalls 118 and 120 of the transition channel 106 between its floor 122 and ceiling 124. This term is thus based on the height h of the channel 106, the fluidic contact angle θ, the increasing angle ϕ at which the channel 106 non-linearly expands in width, and the fluidic surface tension y. More specifically, this term is based on the cosine of the sum of the fluidic contact angle θ and one half of the expansion angle ϕ, multiplied by the width w and two times the fluidic surface tension y.

The net capillary fluidic force F₀ may be any value greater than zero, and in practice is set to a minimum value, such as 10⁻⁶ Newtons for a transition channel 106 that is 31 microns high and is initially 31 microns wide and in consideration of the surface tension of water. For a specified channel height h, a specified fluidic surface tension y, and a specified fluidic contact angle θ, the force balance equation is solved beginning at the initial width w of the transition channel 106 (i.e., the width 108) for the angle ϕ at which the channel 106 is to expand, which in turn yields the width w of the transition channel 106 at the next point along its length 112. This process is repeated point-by-point along the length 112 of the transition channel 106 until the width w of the channel 106 becomes equal to the width 110, or until the expansion angle ϕ becomes equal to 180 degrees, which occurs at a particular width w greater than 200 microns per the line 506 in the specific example of FIG. 5.

Solving the force balance equation for the expansion angle ϕ in this manner therefore maintains a constant net capillary fluidic force F₀ along the length 112 of the transition channel 106. Note that as the expansion angle ϕ widens, at some point (e.g., at a particular width w greater than 200 microns per the line 506 in the example of FIG. 5) the expansion angle ϕ reaches 180 degrees, which means the transition channel 106 can then abruptly increase in width w to the width 110 of the second channel 104. Therefore, there is an upper bound to the length 112 of the transition channel 106, regardless of how large the width 110 is relative to the width 108. That is, solving the force balance equation for the expansion angle ϕ in effect sets the minimum length 112 at which priming can properly occur.

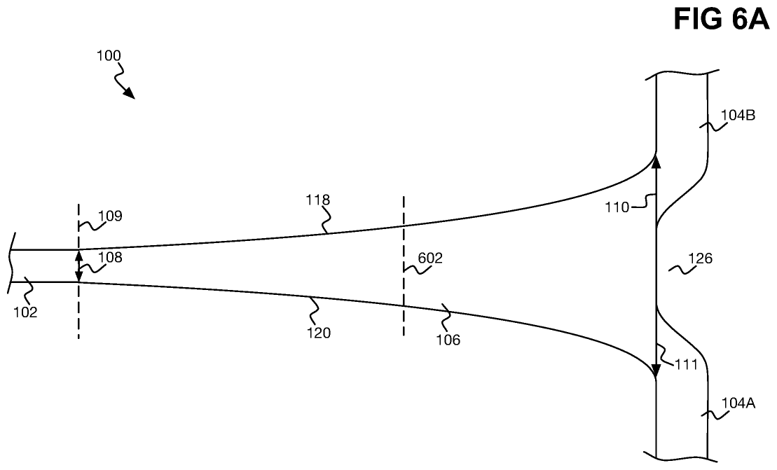

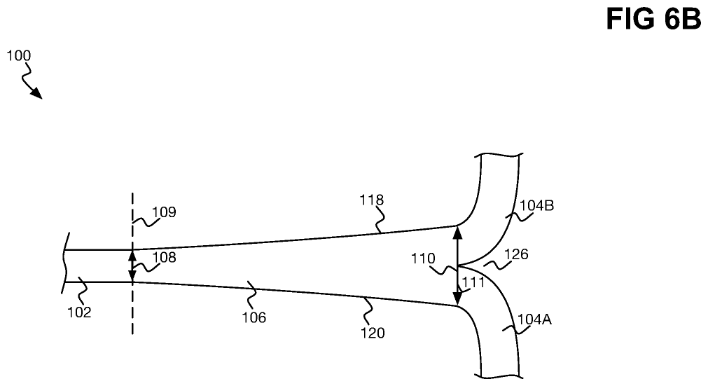

FIGS. 6A and 6B each shows a cross-sectional top view of a different example microfluidic device 100 in which the transition channel 106 non-linearly expands in width along its length 112 in accordance with the described graph 500 of FIG. 5. The microfluidic device 100 again includes the first channel 102 and specifically two second channels 104 into which the transition channel 106 specifically symmetrically two-way splits the first channel 102. Also as before, the first end 109 of the transition channel 106 of the microfluidic device 100 is fluidically connected to the first channel 102, and the second end 111 of the channel 106 is fluidically connected to the second channels 104. The microfluidic device 100 includes a split wedge 126 between the second channels 104.

In both FIGS. 6A and 6B, the transition channel 106 non-linearly expands in width across its length from the width 108 of the first channel 102 at the first end 109 to the width 110 at the second end 111 that is equal to no less than the sum of the widths of the second channels 104 at the second end 111. This non-linear expansion in width is governed by the graph 500 of FIG. 5, such that the sidewalls 118 and 120 flare out in a trumpet-like manner at an increasing expansion angle. The expansion angle at any point along the length of the transition channel 106 is the angle between lines tangential to the sidewalls 118 and 120 of the channel 106. The length of the transition channel 106 in both FIGS. 6A and 6B is the minimum such length at which priming can properly occur, such as under the constraints encompassed by the graph 500.

In FIG. 6A, the width 110 of the transition channel 106 at the second end 111 is much larger than the width 108 at the first end 109. For instance, fabrication constraints may result in the split wedge 126 having a relatively large width at the second end 111 of the transition channel 106, resulting in the width 110 being much larger than the width 108. The width 110 is equal to the sum of the widths of the second channels 104 and the width of the split wedge 126 at the second end 111. The transition channel 106 can, however, abruptly increase in width at the second end 111 to the width 110, because at the second end 111 the expansion angle of the transition channel 106 becomes 180 degrees per the graph 500 of FIG. 5. As such, the length of the channel 106 in FIG. 6A is at its upper bound per the graph 200.

By comparison, in FIG. 6B, the width 110 of the transition channel 106 at the second end 111 is not significantly larger than the width 108 at the first end 109. For instance, the split wedge 126 may be permitted to terminate at a point at the second end 111 of the transition channel 106, resulting in the smaller width 110 in FIG. 6B than in FIG. 6A. The transition channel 106 in FIG. 6B therefore reaches the width 110 at the second end 111 at an expansion angle less than 180 degrees. For sake of illustrative comparison, the second end 111 of the transition channel in FIG. 6B is identified by the dotted line 602 in FIG. 6A.

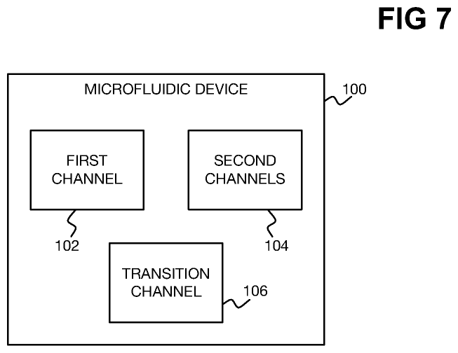

FIG. 7 shows a block diagram of the example microfluidic device 100. The microfluidic device includes a first channel 102 and multiple second channels 104. The microfluidic device 100 includes a transition channel 106 that splits the first channel 102 into the second channels 104. The transition channel 106 has a first end fluidically connected to the first channel 102 and a second end fluidically connected to the second channels 104.

The transition channel 106 expands in width from the width of the first channel 102 at the first end to no less than a sum of widths of the second channels 104 at the second end so as to promote fluid flow from the first channel 102 to the second channels 104. For example, the transition channel 106 may linearly expand in width at an angle no greater than two times a difference between 900 degrees and a fluidic contact angle. As another example, the transition channel 106 may non-linearly expand in width at an increasing angle that maintains a specified positive net capillary fluidic force along a length of the channel 106.

Techniques have been described for promoting fluid flow from a first channel of a microfluidic device to second channels into which the first channel splits, to permit priming to properly occur. Specifically, a transition channel is fluidically connected between the first and second channels, and increases in width from the width of the first channel (where the first channel meets the transition channel) to no less than the sum of the widths of the second channels (where the second channels meet the transition channel) across the length of the transition channel. Such expansion can occur linearly or non-linearly, the former according to a particularly specified expansion angle and the latter according to an increasing expansion angle that maintains a specified positive net capillary fluidic force across the length of the transition channel.

1. A microfluidic device comprising:
a first channel;
a plurality of second channels; and
a transition channel splitting the first channel into the second channels, the transition channel having a first end fluidically connected to the first channel and a second end fluidically connected to the second channels,
wherein the transition channel expands in width from a width of the first channel at the first end to no less than a sum of widths of the second channels at the second end so as to promote fluid flow from the first channel to the second channels.

2. The microfluidic device of claim 1, further comprising:
a split wedge separating adjacent of the second channels at the second end of the transition channel.

3. The microfluidic device of claim 1, wherein the transition channel is a first transition channel, the microfluidic device further comprising:
a plurality of third channels; and
a second transition channel splitting a selected second channel into the third channels, the second transition channel having a first end fluidically connected to the selected second channel and having a second end fluidically connected to the third channels,
wherein the second transition channel expands in width from the width of the selected second channel at the first end to no less than a sum of widths of the third channels at the second end so as to promote fluid flow from the second channel to the third channels.

4. The microfluidic device of claim 1, wherein the transition channel symmetrically or asymmetrically splits the first channel into the second channels.

5. The microfluidic device of claim 1, wherein the width of the first channel and the widths of the second channels are equal to one another.

6. The microfluidic device of claim 1, wherein the transition channel linearly expands in width from the width of the first channel to the sum of the widths of the second channels at an angle no greater than two times a difference between 90 degrees and a fluidic contact angle.

7. The microfluidic device of claim 6, wherein the angle is no greater than 20 degrees.

8. The microfluidic device of claim 1, wherein the transition channel non-linearly expands in width from the width of the first channel to the sum of the widths of the second channels at an increasing angle based on a fluidic contact angle.

9. The microfluidic device of claim 8, wherein the increasing angle maintains a specified positive net capillary fluidic force along a length of the transition channel.

10. The microfluidic device of claim 9, wherein the increasing angle minimizes the length of the transition channel along which the transition channel expands in width.

11. The microfluidic device of claim 9, wherein the specified positive net capillary fluidic force is based on a positive first term contributed by a floor and a ceiling of the transition channel between sidewalls of the transition channel and a negative second term contributed by the sidewalls of the transition channel between the floor and the ceiling of the transition channel,
and wherein the positive first term and the negative first term are each further based on fluidic surface tension.

12. The microfluidic device of claim 9, wherein the specified positive net capillary fluidic force is based on a positive first term and a negative second term,
wherein the positive first term is based on a width of the transition channel and the fluidic contact angle,
wherein the negative second term is based on a height of the transition channel, the fluidic contact angle, and the increasing angle at which the transition channel non-linearly expands in width,
and wherein the positive first term and the negative first term are each further based on fluidic surface tension.

13. The microfluidic device of claim 9, wherein the specified positive net capillary fluidic force is equal to 2y[w cosθ+h cos(θ+^{ϕ}/₂)], wherein y is fluidic surface tension, θ is the fluidic contact angle, ϕ is the increasing angle at which the transition channel non-linearly expands in width, w is a width of the transition channel, and h is a height of the transition channel.

14. A microfluidic device comprising:
a first channel;
a plurality of second channels; and
a transition channel splitting the first channel into the second channels, the transition channel having a first end fluidically connected to the first channel and a second end fluidically connected to the second channels,
wherein the transition channel linearly expands in width from a width of the first channel at the first end to no less than a sum of widths of the second channels at the second end at an angle no greater than two times a difference between 90 degrees and a fluidic contact angle.

15. A microfluidic device comprising:
a first channel;
a plurality of second channels; and
a transition channel splitting the first channel into the second channels, the transition channel having a first end fluidically connected to the first channel and a second end fluidically connected to the second channels,
wherein the transition channel non-linearly expands in width from a width of the first channel at the first end to no less than a sum of widths of the second channels at the second end at an increasing angle maintains a specified positive net capillary fluidic force along a length of the transition channel.
